(19) United States
(12) Patent Application Publication
(10) Pub. No.: US 2012/0164619 A1
(43) Pub. Date: Jun. 28, 2012

(54) Educational Assessment System and Associated Methods

(75) Inventor: Derrick Meer, Orlando, FL (US)

(73) Assignee: Via Response Technologies, LLC

(21) Appl. No.: 13/334,993

(22) Filed: Dec. 22, 2011

Related U.S. Application Data
(60) Provisional application No. 61/425,934, filed on Dec. 22, 2010.

(51) Int. Cl. G09B 5/00

(52) U.S. Cl. 434/350

(57) ABSTRACT

A system and method are provided for allowing a member of an audience to interact with a presenter in an organizational environment by accessing network software as a service in a browser or native application software operable with a processor. Such a system and method improves classroom participation and assessing effectiveness of presentation. The system includes software elements that are useable by accessing the cloud network or as may be installable on a local processor and on a communication device, which can comprise a computer, a mobile phone, or a hand held device in general. Presenter and audience member interfaces are provided for composing, posing, and answering questions, participating in a class blog, and receiving real-time data on class comprehension of student learning objectives.

### CROSS REFERENCE TO RELATED APPLICATION

This application claims the benefit of U.S. Provisional Application No. 61/425,934, having filing date of Dec. 22, 2010 for Educational Assessment System and Associated Methods, the disclosure of which is hereby incorporated by reference herein in its entirety, and commonly owned.

### FIELD OF INVENTION

The present invention relates to systems and methods for educational assessment, and, more particularly, to such systems and methods that employ student-activated response technology.

### BACKGROUND

Audience response systems are known in the art for use in educational settings, and have been shown to increase attention and enhance learning. In some systems radio-frequency (RF) handheld devices, commonly known as “clickers,” are used by students to transmit answers to questions posed by the instructor. These answers are received by an instructor processor, which can process the answer data in a number of ways, including presenting graphical displays of the collected answer data to indicate class comprehension of the subject at hand.

Other systems are known in the art that employ “virtual clickers,” which are created by installing software on a student computing device such as a computer or mobile phone. Interaction is then mediated over the Internet between the student's device and the instructor processor.

Currently, all systems and designs are “many to one” allowing members of an audience, such as a student in a classroom environment to interact with one presenter, the teacher. Whether it is a hardware remote or native application, the delivery of the data is to a client/server application. This is an inherent limitation in current presentation systems.

The teachings of the present invention allow one to overcome such limitations by providing a “many-to-many” styled communications system and method. That is, the “many” within a classroom environment, whether real or virtual can now communicate with “many” others, whether they be other members of an audience or multiple presenters.

### SUMMARY

The present invention is directed to a system and method for improving group participation, such as in a classroom or lecture, and assessing effectiveness of a presentation. A method aspect of the invention is directed to a method for a member of an audience to interact with a presenter in an organizational environment by accessing network software as a service in a browser or native application software operable with a processor. The method may comprise placing a member device in signal communications with the processor through at least one of an Internet connection and an Intranet connection. The network software may be accessed by the presenter using a presenter device. A display is provided on the presenter device. Members of the audience may select a presentation session to join, wherein questions may be transmitted to the members in the audience through the presenter device. A screen may be opened by at least a portion of the members of the audience on their individual member device, wherein each member is permitted to log in, and wherein a plurality of screens is made available on the displays as mediated by the presenter through the network software. The network software may be made available through a dedicated processor or through the network software as a service referred to as a “cloud” to those of skill in the art, herein referred to as a cloud processor.

The system may include software elements that are installable on a teacher processor and on a student communication device, which may comprise a computer or a mobile phone, by way of example.

The most fundamental change to current art is the change of core architecture presented by the present invention. Currently, all systems and designs are “many-to-one.” That is, an audience, such as a student class interacts with one presenter, the teacher. Whether it is a hardware remote or native application, the delivery of the data is to a client/server application. This inherent limitation is addressed by and is overcome by the teachings of the present invention. The present invention provides a “many to many” styled communications. That is, the “many” within a classroom environment, whether real or virtual can now communicate with “many” others, whether they be other members of an audience or multiple presenters. Yet further, multiple delivery modalities (e.g. IP and SMS) are made available.

With regard to a teaching environment, and as herein presented by way of example, more than just the instructor can view live data in classroom. Many instructors across many classrooms can view the same data coming in from many classrooms with a voting device of any type. The plurality of screens allow for the same question to be presented in multiple classrooms while multiple instructors review. The plurality of screens allows the instructor or instructors to see the data of the students at individually identifiable view that is impossible in single presentation systems. The “many-to-many” architecture furthers the present invention through personalization and self service for the student. The devices become irrelevant because information transfer is tied to a name, a person, instead of hardware, such as a clicker and clicker number. The C#, Java and objective C clients provide for legacy clickers to participate in the benefits of a many-to-many architecture as herein presented.

Presenter and audience member interfaces, such as a teacher and student interfaces, may be provided for composing, posing, and answering questions, participating in a class blog, and receiving real-time data on class comprehension of student learning objectives.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a diagrammatically illustration of one presentation system in keeping with the teachings of the present invention;

FIGS. 2A and 2B are flowcharts of an exemplary method of the present invention;

FIG. 3 is a diagrammatical illustration of an exemplary system of the present invention;

FIGS. 4 and 5 are exemplary teacher interface presentations, wherein as in FIG. 6, the instructor login allows instructors to have all data cloud based instead of on an individual hard drive; and

FIG. 6 is an exemplary student login interface and screen shot for the system of the present invention, wherein screen shots may include selecting from available modules in a particular class, selecting from among media available for a particular class, displaying attendance records and checking in to a class, performing a homework assignment, multi question quizzes, answering a poll question and displaying correctness of the answer and class results, viewing answers submitted by students in a class and ranked by some criterion, displaying grade distributions for a class, displaying grade distributions based upon factors determining the grade, viewing a student's own grade results for the class, displaying student and teacher notifications, and the like.

### DETAILED DESCRIPTION OF THE EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

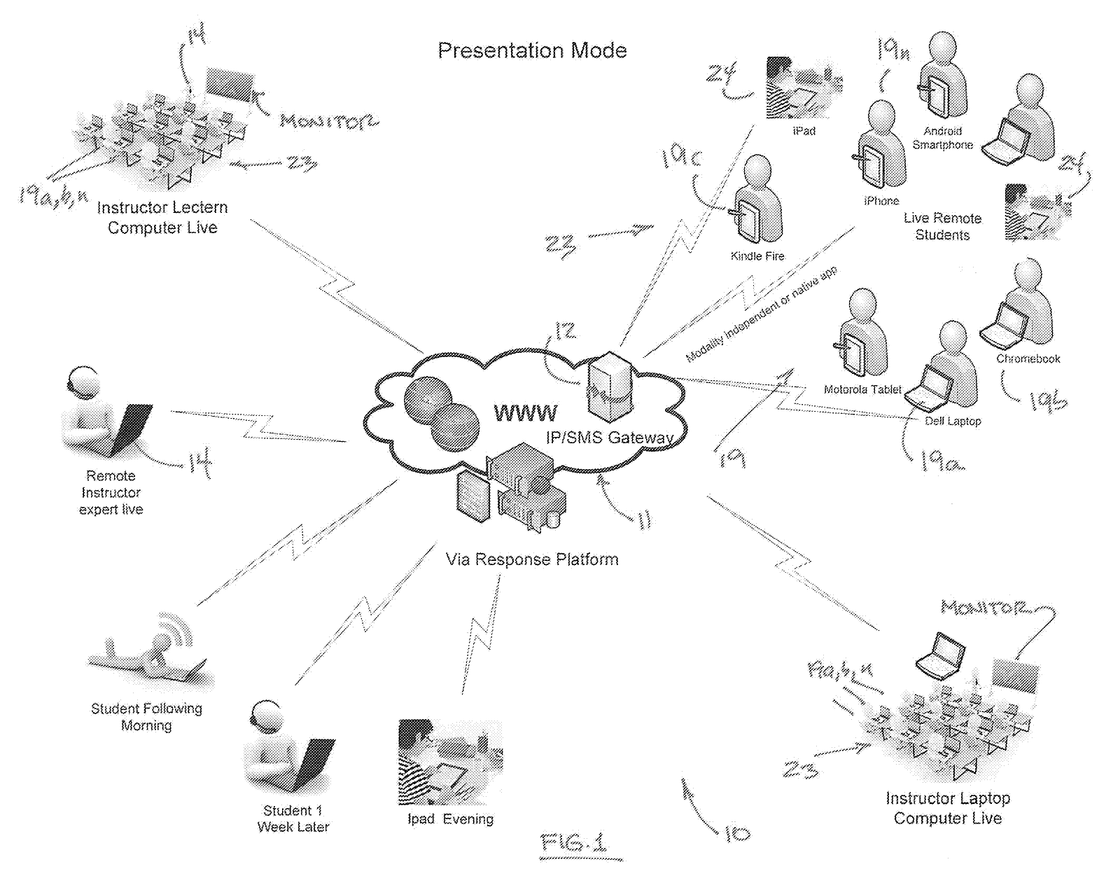

With reference initially to FIG. 1, embodiment of the invention provide a system 10 that permits a member of an audience, such as students herein described by way of example, to interact with a presenter or multiple presenters, herein described as a teacher by way of example, in an organizational environment, such as a dedicated classroom or as remotely connected participants, by accessing network software 11 as a service in a browser or native application operable with a processor 12. As is understood by those skilled in the art, a browser includes software application for retrieving and presenting information resources on the World Wide Web.

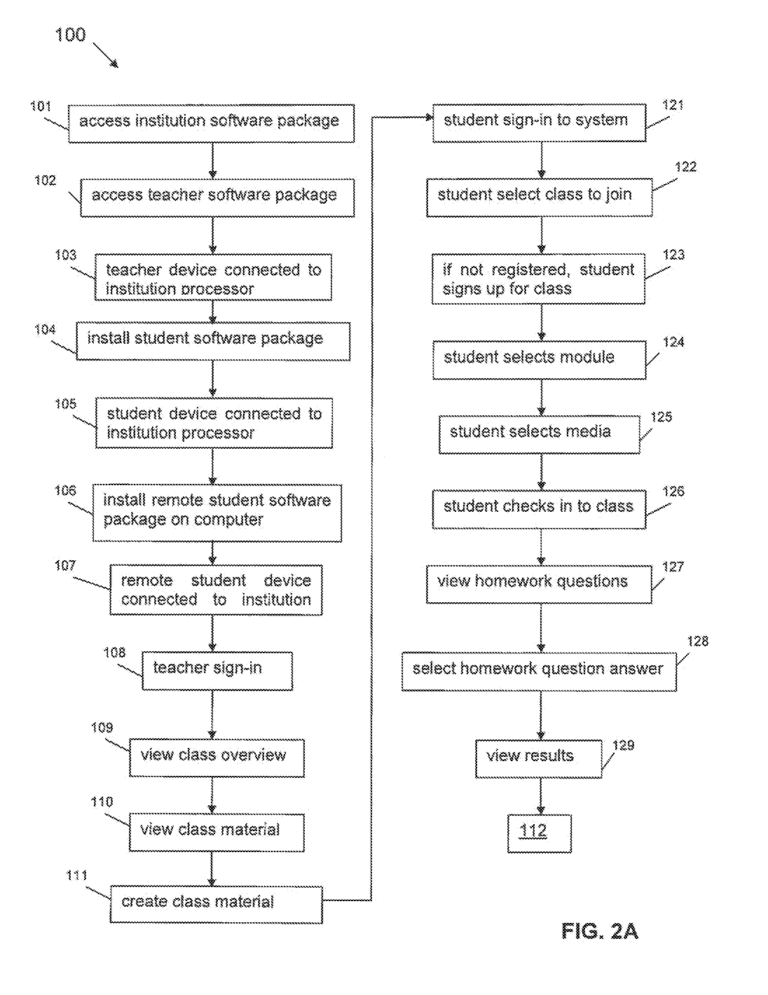

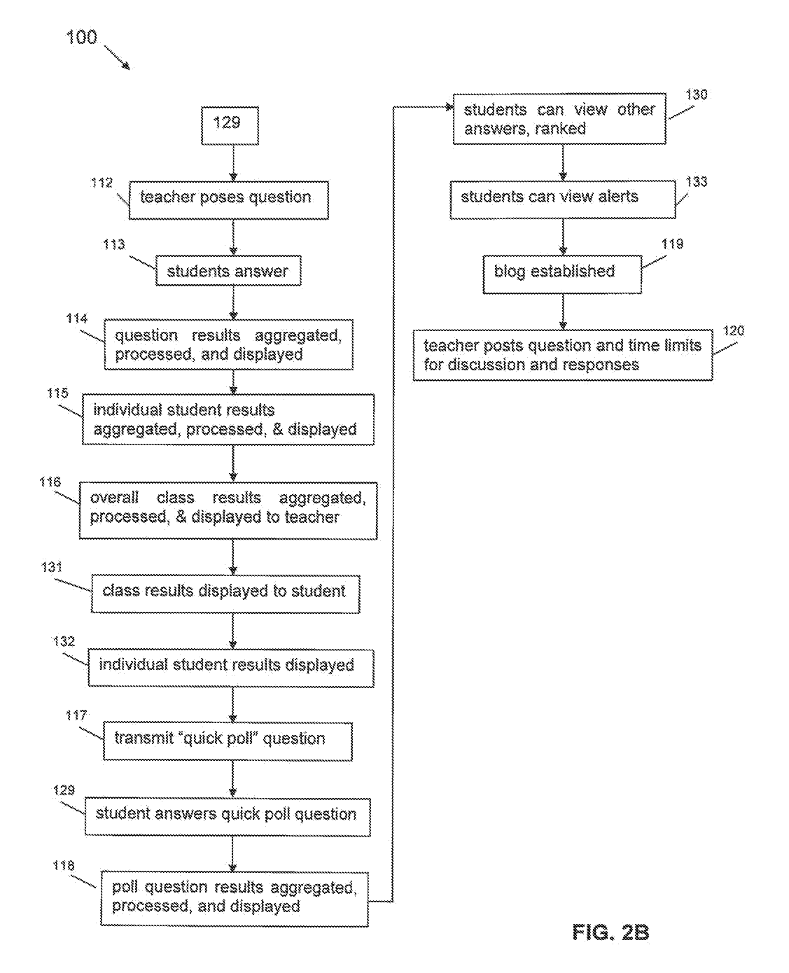

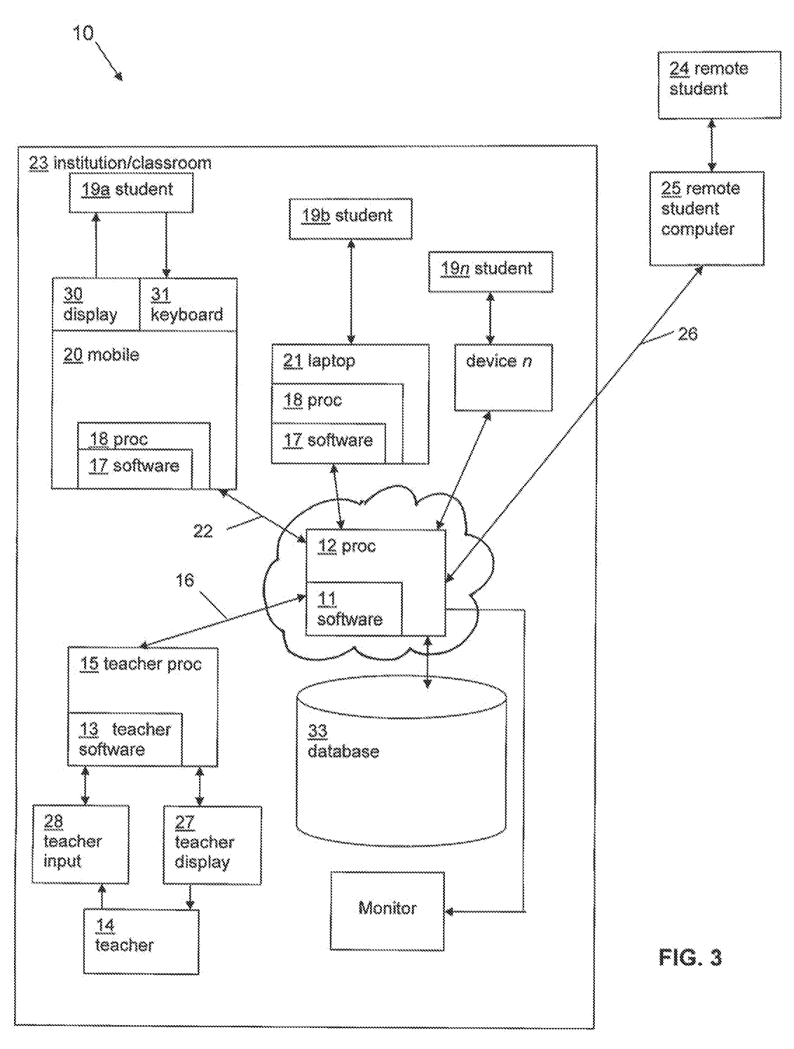

With continued reference to FIG. 1 and now to FIGS. 2A, 2B and 3, one method according to the teachings of the present invention comprises 105 placing a member device 19 in signal communications with the processor 12 through a wireless connection such as an Internet connection or Intranet connection. The network software 11 is accessed by the presenter using a presenter device 14, wherein a display 27 is presented on the presenter device. The member of the audience, such as a student, selected 122 a presentation session to join 246. A question may then be administered 112 to a plurality of members in the audience through the presenter device 14. A screen may be opened 121 by at least a portion of the members of the audience on the member device 14, wherein each member is permitted to log in 245, and wherein a plurality of screens is available on the displays 30 as mediated by the presenter through the network software 11, such as is available through “cloud computing.” As is known by those of skill in the art, cloud computing includes a delivery of computing as a service rather than a product, whereby shared resources, software, and information are provided to computers and other devices as a metered service over a network, typically the Internet.

By way of example, reference will herein now be made to a teacher and a student. However, those of ordinary skill in the art will easily understand how the systems and methods herein presented are applicable in presentation environments other that for institutions, such as schools.

With reference again to FIGS. 2A and 2B, the method 100 herein presented by way of example will be directed to establishing and using a classroom interaction system and to such a classroom interaction system 10, as illustrated with reference to FIG. 3. The method 100, which includes actions by teacher and student, comprises establishing an interaction system 10 for an educational institution by accessing software as a service through a network cloud 11, by way of example, in a browser or in a native application, for example, using a processor 12. Alternatively, the processor 12 may be an institution processor, and the method 100 may include installing an institution software package 11 on the institution processor 12. See block 101 in the flow chart for the method 100, herein described by way of example. With continued references to FIG. 3, a teacher software package 13 may also be accessed (see block 102) by a teacher device 14, which typically comprises a computer 15, although this is not intended as a limitation. By way of example, C# or a Java™ application can be installed on the computer 15 presenting the information for accommodating legacy clicker systems that utilize hardware in the classroom 23. The teacher device 14 is placed (see block 103) in signal communication with the institution processor 12 via, for example, an intranet or Internet connection 16.

As will come to the mind of those skilled in the art and now having the benefit of the teachings of the present invention, the teacher and student devices 14, 19 may include similar hardware.

With continued reference to FIG. 3, a student software package 17 is also installed on a processor 18 of a plurality of students 19a, 19b, . . . 19n devices (see block 104), which typically comprise at least one of a handheld device such as a mobile phone 20 or a laptop computer 21. The student devices 20, 21 are able to be placed (see block 104) in signal, typically wireless, communication 22 with the institution processor 12, although these are not intended as limitations. These students 19a, 19b, . . . 19n are be positioned in a classroom 23 when interacting with the system 10. As will be appreciated by those skilled in the art, now having the benefit of the teachings of the present invention, students may be in a real classroom, a remote classroom, a virtual classroom, as may also be the presenter. For the example herein described by way of example, the student software package 17 can also be installed on a remote student 24 device (block 106) that could also comprise, for example, a computer 25. The remote student device 25 is placeable in signal, typically Internet, communication 26 with the institution processor 12 (see block 107). Connection may be through a web browser as an alternate connection via a native application.

The teacher device 14 has a display 27 and an input, typically a keyboard 28, both in signal communication with the institution processor 12 via the teacher processor 15. Each of the student devices 20, 21, 25 has a display 30 and an input, typically a keyboard 31, both in signal communication via the student device processor 18 with the institution processor 12, wherein the institution processor may be an institution cloud processor.

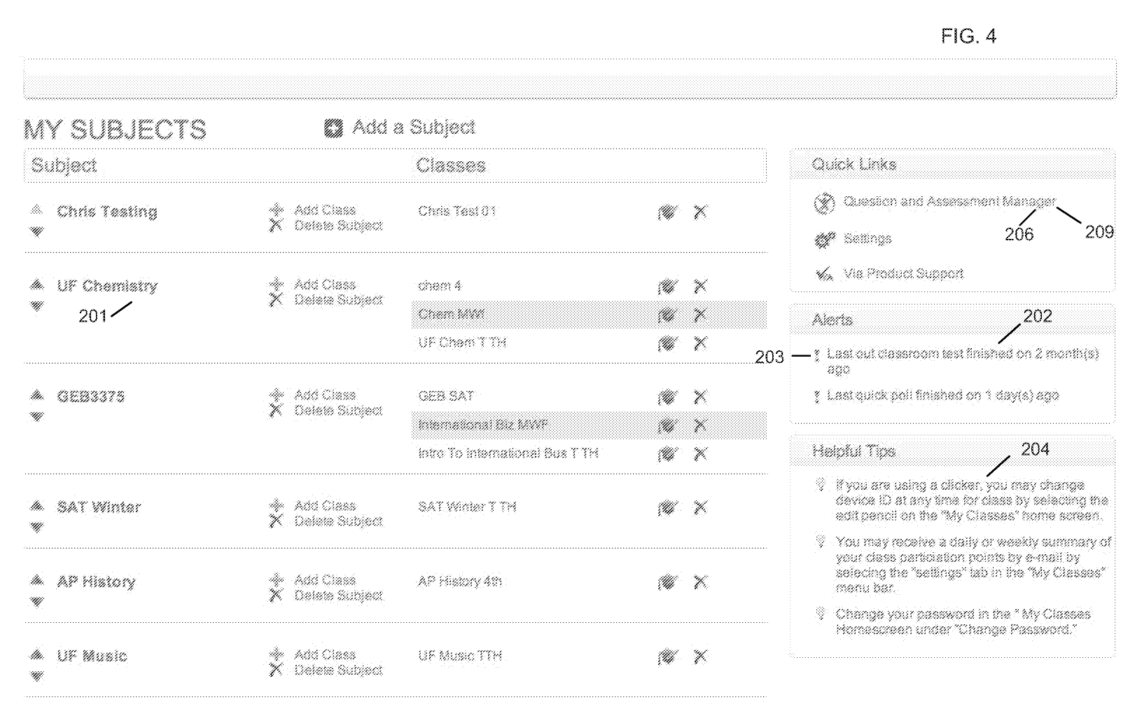

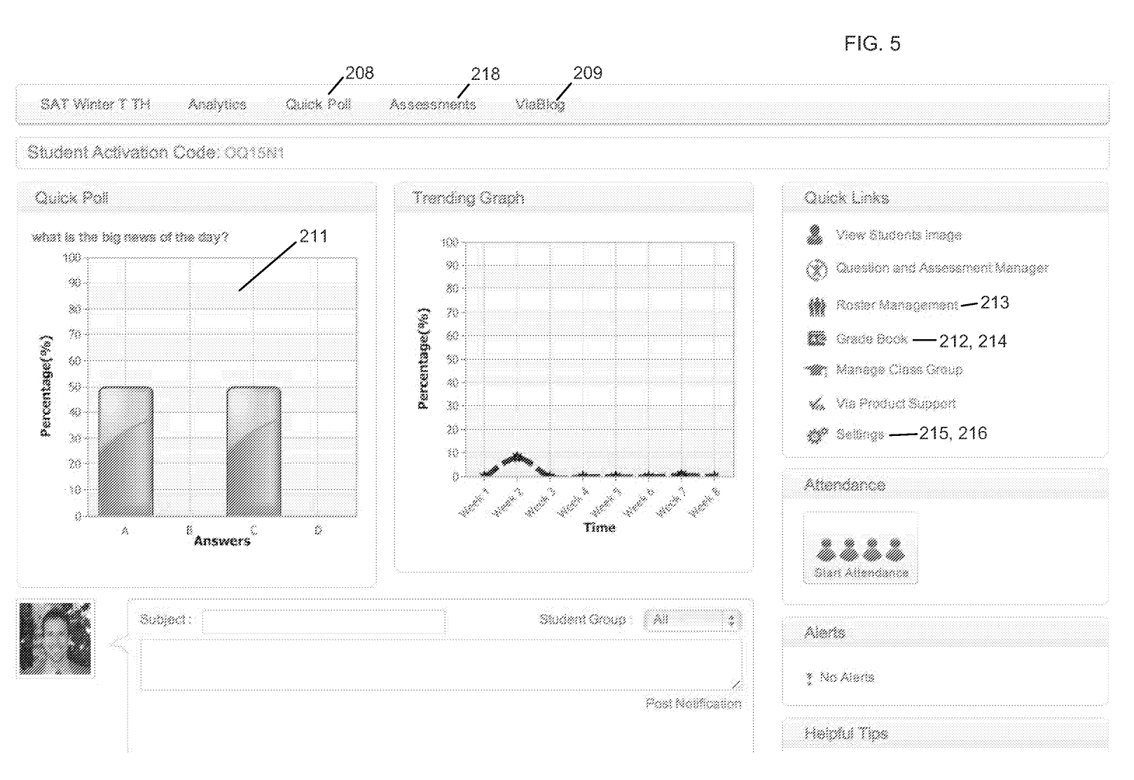

A teacher, through use of the teacher device 14 can view on the display 27 a plurality of screens as mediated by the teacher software package 13. Exemplary screens are illustrated in FIGS. 4 and 5, the functions of which will be discussed in the following description.

The teacher launches a plurality of screens with independent but symbiotic functionality as mediated by the teacher and the software package. Unlike typical applications well known in the art, an embodiment of the present invention has a single view of assessments and response shared by the students and the teachers. Exemplary screens with independent views allow the teacher to see all real time data rolled up and at a personally identifiable student level. A single data view solution, well known the art, is prohibited by law and may be governed by Family Education Rights and Privacy Act (FERPA). The present invention allows for dynamic peer to peer activities that are monitored by the teacher. The teacher knows which students are proficient learners and those individual students that need remediation.

With continued reference to FIGS. 2A and 2B, after signing in (see block 108), a teacher 14 can view an opening page 200, as illustrated with reference to FIG. 4, that lists a schedule of all of his/her classes 201 that are enabled to work with the instant system 10. A list of alerts 202 is also displayed, including the status of blogs (to be discussed later in this disclosure) and pending action items such as quizzes ready for review 203. A help section 204 is also displayed to assist the teacher in navigating the teacher software 13. The teacher device 14 can also send out invitations to join the class and set up class identification (ID) codes for registration purposes, by way of example. The codes are then passed through a URL string to greatly simplify the registration code, an improvement over well know methods.

With continued reference to FIG. 4, selecting one of the classes 201 brings up a class overview page 205, as illustrated with reference to FIG. 5 (see block 109 of FIG. 2A), which contains links for assessment management 206, importing questions 207, and creating a quick poll 208. Blog commands 209 are also presented, as well as class-specific alerts 210. A visual display, such as a pie chart or bar chart 211, graphically displays class average data 212. This page 205 also permits the teacher 14 to manage a class roster 213, interact with the class grade book 214, post student notifications 215, and adjust settings 216.

Selecting the assessment management link 206 brings up a screen for viewing class material (see block 110) and selecting 218 to create future assessments. The teacher can view homework and past assessments, and see which assessments may be incomplete, by way of example.

Selecting a link to create new assessments brings up a question creation screen, for inputting different types of questions or import questions from a database 33, illustrated with reference again to FIG. 4, in signal communication with the institution processor 12 (see also block 111 of FIG. 2A). The questions can be used in tests or homework assignments. Timers can also be added for quizzes and tests, either as a whole or by individual question, and due dates for homework assignments set. Further, questions can be assigned a weighting factor to determine how much that question will count in an overall grade.

With continued reference to FIG. 2B, as a question is administered (see block 112) and the results received (see block 113) aggregated, various types of analytics are dynamically calculated and displayed for class results (see block 114), such as in vertical bar-graph format, pie-chart format, horizontal bar-graph format, “gas-gauge” format, or in curve format including a smoothed, slidable curve, although these are not intended as limitations. An indicator of a student learning objective can also be displayed against which the analytics can be compared. Individual student results can also be transmitted (see block 115 of FIG. 2B), which will be further described below.

As will come to the mind of those skilled in the art, now having benefit of the teachings of the present invention, class averages can also be displayed in graph format 235 (see also block 116 of FIG. 1B), indicating, for example, a time line of tests and quizzes. Data is now available in the cloud processor 11 and can be reviewed anywhere and at any time as permitted by the presenter, by way of example using a browser, and can be rolled up to a data storage 33 for review of longitudinal data across classes, instructors, institutions and regions. Furthermore, data is now able to be compared against a student learning objective longitudinally and down to an individual student as defined by the teacher, by way of example.

Interest can be maintained during class by transmitting a “quick poll” question (see block 117 of FIG. 2B), the results of which can be aggregated, processed, and displayed in, for example, bar-graph form (see block 118 of FIG. 2B) or pie-chart form, and can also display a list of those students who have participated. A timer can also be set for submitting a quick poll response.

Using the teacher device 14, a teacher can elect to establish a class blog specific to a class (see block 119 of FIG. 2B), for which questions can be posted and time limits for discussions and responses (see block 120 of FIG. 2B).

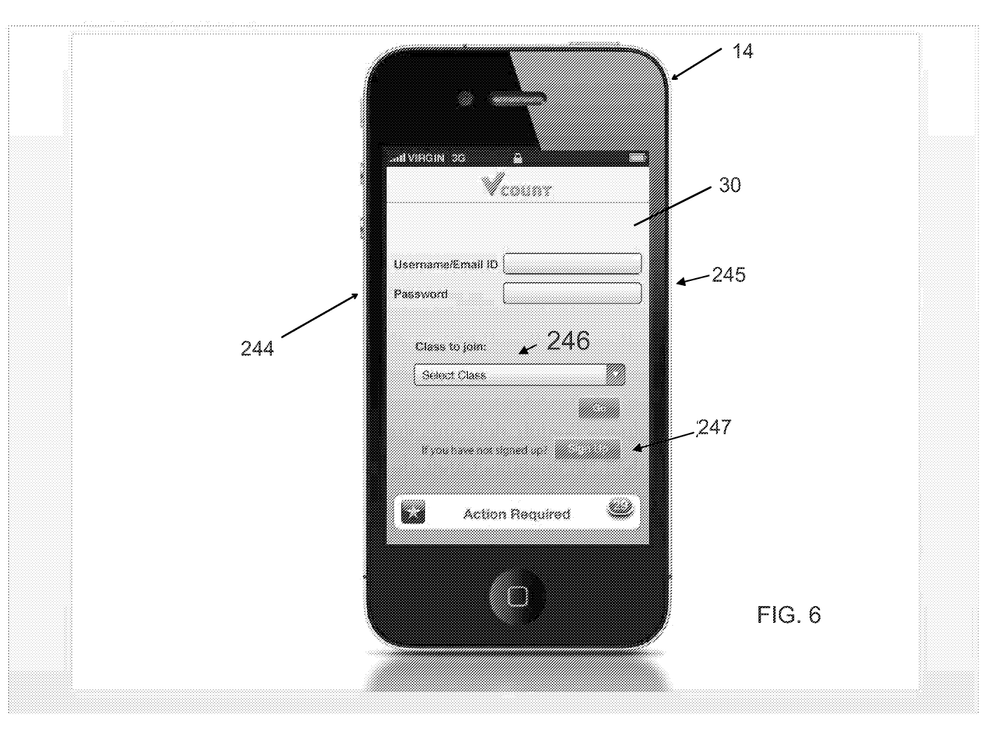

With reference again to FIGS. 1 and 4, and to 6 the student devices 19a, 19b, . . . 19n, 24 can include a plurality of screens on their displays 30 a plurality of screens as mediated by the student software package 17. An exemplary screen is illustrated in FIG. 6. As herein presented, screen shots may include selecting from available modules in a particular class, selecting from among media available for a particular class, displaying attendance records and checking in to a class, performing a homework assignment, multi question quizzes, answering a poll question and displaying correctness of the answer and class results, viewing answers submitted by students in a class and ranked by some criterion, displaying grade distributions for a class, displaying grade distributions based upon factors determining the grade, viewing a student's own grade results for the class, displaying student and teacher notifications, and the like.

As illustrated with reference again to FIG. 1 and as illustrated with reference to FIGS. 4-6, the instructor login allows instructors to have all data cloud based instead of on an individual hard drive.

As illustrated with reference to FIG. 1 and again to FIG. 2B, a student opening screen 244 permits the student device 19a, 19b, . . . 19n, 24 to log in 245 (see block 121 in FIG. 2B), select which class to join 246 (see block 122 of FIG. 1B), and, if not already signed up, sign up for the class 247 (see block 123 of FIG. 1B).

As may be displayed on alternate screens, a class opening page permits the student devices 19a, 19b, . . . 19n, 24 to select a module to access (see block 124 of FIG. 2B). As illustrated with reference again to FIG. 1, a plurality of media may also be offered (see block 125 of FIG. 1 B) for the class. The present invention includes a login to the cloud processor 11 and not to a client server as is typical in the art. Therefore, the “many-to-many” architecture is available and not simply the “many-to-one” as required in typical systems and methods.

By way of example, an attendance module displays the student's attendance record and permits the student to check in for full participation (see block 126 of FIG. 2A), for example, by entering a password. Alternatively, a bar code could be provided that would be read for class sign-in, or GPS could be used to check in for a class, as illustrated with reference to FIG. 19A. A homework module displays homework questions (see block 127 of FIG. 2A) with, for example, multiple-choice answers among which the student through the student device 19a, 19b, . . . 19n, 24 can select one (see block 128 of FIG. 2A). As will be understood, questions available using embodiments of et present invention may include true and false, yes and no, fill in the blank, matching, any creative question formulated by the teacher.

A quick poll module, which will typically have a finite response time permitted, displays a poll question, correctness of answer, and overall class results (see block 129 of FIG. 1A). The student devices 19a, 19b, . . . 19n, 24 can also view other students' answers (with student anonymity preserved), presented in some rank order, for example, by those deemed to be the best responses, and can include comments by the teacher 14 or other student devices 19a, 19b, . . . 19n, 24 (see block 130 of FIG. 1 B).

Overall class grades can be viewed by the student devices 19a, 19b, . . . 19n, 24 (see block 131 of FIG. 1B) as a pie chart, for example, or as a numerical list. The students through use of the student devices 19a, 19b, . . . 19n, 24 can also access his/her own grades (see block 132 of FIG. 2B). The student devices 19a, 19b, . . . 19n, 24 can have the option, for example, by clicking on one of the percentages 262, to view his/her raw totals and assessments for review.

The student devices 19a, 19b, . . . 19n, 24 can also access alerts (see block 133 of FIG. 2B), such as assignment alerts and teacher notifications. Further, such alerts and other communications can be personalized and “pushed” to an individual student, thereby maintaining some level of secrecy in that communication.

It can be seen that the present system 10 and method 100 satisfy a long-felt need in class communication, serving to maintain student interest and attention, and thereby fostering better learning, as well as providing a valuable real-time tool for teachers to ascertain how well material is being absorbed by the students. Remote students are drawn into the class more effectively, thereby also increasing their sense of participation and absorption of material.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included with the scope of the appended claims.

That which is claimed:

1. A method for a member of an audience to interact with a presenter in an organizational environment by accessing network software as a service in a browser operable with a processor, the method comprising:
placing a member device in signal communications with the processor through at least one of an Internet connection and an Intranet connection;
accessing the network software by the presenter using a presenter device;
providing a display on the presenter device;
selecting a presentation session to join by the member;
administering a question to a plurality of members in the audience through the presenter device; and
opening a screen by at least a portion of the members of the audience on the member device, wherein each member is permitted to log in, and wherein a plurality of screens is available on the displays as mediated by the presenter through the network software.

2. The method according to claim 1, wherein accessing network software comprises accessing the network software located on a cloud processor.

3. The method according to claim 1, wherein accessing the network software by the presenter comprises accessing the network software by a plurality of presenters.

4. The method according to claim 1, further comprising:
installing organization software on an organization processor; and
installing audience software on a presenter processor, wherein the presenter and the member communicate through the organization processor using the organization software.

5. The method according to claim 1, further comprising:
transmitting a response to the presenter device by at least a portion of the members using the member device; and
aggregating the responses received by the presenter device.

6. The method according to claim 1, further comprising
installing member software on a remote member device, wherein the remote member device is out of the organizational environment; and
placing a remote member device in signal communications with the processor through at least one of the Internet and the Intranet connection.

7. The method according to claim 1, further comprising placing the presenter device in signal communications with the processor through at least one of the Intranet connection and the Internet connection, thus allowing communicating with a many-to-many.

8. The method according to claim 7, wherein the many-to-many communicating includes at least one of one and multiple presenters interacting with one and multiple members, one and multiple presenters interacting with another one and the multiple preventers, and one and multiple members interacting with another one and the multiple members.

9. The method according to claim 1, further comprising the member registering for access to the presentation session.

10. The method according to claim 1,
wherein the organizational environment is an institution of learning,
wherein the member is a student enrolled at the institution of learning, and
wherein the presenter is a teacher at the institution of learning.

11. The method according to claim 10, wherein the teacher launches a plurality of screens with independent but symbiotic functionality as mediated by the teacher, wherein a single view of assessments and responses is shared by the students and the teachers, wherein exemplary screens with independent views allow the teacher to see all real time data and a personally identifiable student level, and wherein dynamic peer to peer activities are monitored by the teacher, the teacher thus knowing which students are proficient learners and which need remediation.

12. The method according to claim 10, wherein the processor comprises an organization processor, and wherein an organization software package is available to the teacher and the student through the Internet connection.

13. The method according to claim 1, further comprising
installing native application software on an audience computer accessible by the member devices, wherein at least one of the plurality of member devices includes at least one of a handheld device, a mobile phone, and a laptop computer; and
placing the member devices in signal communications with the processor.

14. The method according to claim 13, further comprising installing at least one native application in C#™, Java™, objective C and programming language for accommodating proprietary clicker systems, wherein software translates and interprets responses and delivers the responses to the processor wherein the presenter dynamically reviews results from the member devices.

15. The method according to claim 1, further comprising requiring an authorization code for the member devices to interact with the processor.

16. The method according to claim 15, further comprising:
transmitting an assessment poll to the member devices;
aggregating results of the poll; and
transmitting the results of the poll to the member devices,
wherein the members of the audience who have participated are identified on the presenter device.

17. The method according to claim 16, wherein the poll transmitting comprises:
displaying a quick poll module having a preselected response time defined by the presenter for permitting the member to respond; and
displaying the quick poll question, correctness of answer, and overall audience results in response to the quick poll module use by the plurality of screens, wherein the results are stored in the processor.

18. The method according to claim 1, further comprising
accessing a module by the member, wherein the module is displayed on an audience opening page presented by the presenter through the presenter device; and
displaying a work module (FIG. 20) to the member including questions.

19. The method according to claim 1, further comprising providing a plurality of media to the members for selecting a session.

20. The method according to claim 1, further comprising providing access to an attendance module by the member, the attendance module including an attendance record for the member, the access available to the member by a password, the member then having full participation once entering the password.

21. The method according to claim 1, further comprising one of the plurality of member devices communicating with another of the plurality of member devices, wherein comments by the presenter are delivered through the presenter device and comments by the members are delivered through the member device.

22. The method according to claim 1, further comprising accessing personal data by the member through the member device, wherein the personal data is not available to another member.

23. The method according to claim 1, further comprising:
displaying audience results on at least one of a local monitor and the member devices;
transmitting individual member results to respective member devices; and
displaying audience information on at least one of the local monitor and the member devices.

24. The method according to claim 23, further comprising establishing a blog by the presenter using the presenter device, wherein the blog is specific to a preselected session.
